(19) United States
(12) Patent Application Publication
(10) Pub. No.: US 2010/0319346 A1
(43) Pub. Date: Dec. 23, 2010

(54) SYSTEM FOR RECOVERING WASTE HEAT

(75) Inventors: Gabor Ast, Garching (DE); Thomas Johannes Frey, Ingolstadt (DE); Pierre Sebastien Huck, Munich (DE); Herbert Kopecek, Hallbergmoos (DE)

Correspondence Address: GENERAL ELECTRIC COMPANY;GLOBAL RESEARCH, ONE RESEARCH CIRCLE, BLDG. K1-3A59, NISKAYUNA, NY, 12309, US

(73) Assignee: GENERAL ELECTRIC COMPANY, SCHENECTADY, NY (US)

(21) Appl. No.: 12/489,459

(22) Filed: Jun. 23, 2009

(51) Int. Cl. F02G 5/04; F01K 23/04; F01K 25/00

(52) U.S. Cl. 60/616; 60/651; 60/655; 60/671; 60/698

(57) ABSTRACT

A waste heat recovery system includes at least two integrated rankine cycle systems coupled to at least two separate heat sources having different temperatures. The first rankine cycle system is coupled to a first heat source and configured to circulate a first working fluid. The second rankine cycle system is coupled to at least one second heat source and configured to circulate a second working fluid. The first and second working fluid are circulatable in heat exchange relationship through a cascading heat exchange unit for condensation of the first working fluid in the first rankine cycle system and evaporation of the second working fluid in the second rankine cycle system. At least one recuperator having a hot side and a cold side is disposed in the first rankine cycle system, second rankine cycle system, or combinations thereof. The at least one recuperator is configured to desuperheat and preheat the first working fluid, second working fluid, or combinations thereof.

### BACKGROUND

The embodiments disclosed herein relate generally to the field of power generation and, more particularly, to a system and method for recovering waste heat from a plurality of heat sources having different temperatures, for generation of electricity.

Many power requirements could benefit from power generation systems that provide low cost energy with minimum environmental impact and that may be readily integrated into existing power grids or rapidly sited as stand-alone units. Combustion engines such as micro-turbines or reciprocating engines generate electricity at lower costs using commonly available fuels such as gasoline, natural gas, and diesel fuel. However, atmospheric emissions such as nitrogen oxides (NOx) and particulates are generated.

One method to generate electricity from the waste heat of a combustion engine without increasing the output of emissions is to apply a bottoming cycle. Bottoming cycles use waste heat from a heat source, such as an engine, and convert that thermal energy into electricity. Rankine cycles are often applied as the bottoming cycle for combustion engines. Rankine cycles are also used to generate power from geothermal or industrial waste heat sources. A fundamental organic Rankine cycle includes a turbogenerator, a preheateriboiler, a condenser, and a liquid pump.

In one method to generate electricity from waste heat, single cycle system or two-cycle systems are used in heat recovery applications with waste heat sources of different temperature levels. Single-cycle configurations collect heat from the different waste heat locations in a serial arrangement of heat exchangers with an intermediate heating fluid. In two-cycle configurations, the hot heat source heats a high-boiling point liquid in a top loop, and the cold heat source heats a low-boiling point liquid in a separate bottom loop. The two-cycle system generally achieves a better performance than a single cycle. Since components in the two-cycle system are more complex and require more components, the overall cost of the two-cycle system is significantly higher.

In another conventional system provided to generate electricity from waste heat, a cascaded organic rankine cycle system for utilization of waste heat includes a pair of organic rankine cycle systems. The cycles are combined, and the respective organic working fluids are chosen such that the organic working fluid of the first organic rankine cycle is condensed at a condensation temperature that is above the boiling point of the organic working fluid of the second organic cycle. A single common heat exchanger is used for both the condenser of the first organic rankine cycle system and the evaporator of the second organic rankine cycle. A cascaded organic rankine cycle system converts surplus heat into electricity within certain temperature ranges but does not recover waste heat over a wide temperature range.

In a cascaded organic rankine cycle system, the fluid at the outlet of the expander of the top loop and bottom loop can be in a superheated gas state. In such a system, the superheated gas has to be cooled down to a saturated gas state, before being condensed. This cooling of the superheated gas can be done either in a condenser/evaporator of the top loop or a condenser of the bottom loop. The heat of the desuperheating process is discarded to the bottom loop via the condenser/evaporator or to the ambient surroundings via the condenser of the bottom loop.

It would be desirable to have a cascaded organic rankine cycle system that effectively uses the heat of the desuperheating process for increasing net power output generated by the system.

### BRIEF DESCRIPTION

In accordance with one exemplary embodiment disclosed herein, a waste heat recovery system including at least two integrated rankine cycle systems is provided. The system includes a heat generation system comprising at least two separate heat sources having different temperatures. A first rankine cycle system is coupled to a first heat source among the at least two separate heat sources and configured to circulate a first working fluid. The first rankine system is configured to remove heat from the first heat source. A second rankine cycle system is coupled to at least one second heat source among the at least two separate heat sources and configured to circulate a second working fluid. The at least one second heat source includes a lower temperature heat source than the first heat source. The second rankine cycle system is configured to remove heat from the at least one second heat source. The first and second working fluids are circulatable in a heat exchange relationship through a cascaded heat exchange unit for condensation of the first working fluid in the first rankine cycle system and evaporation of the second working fluid in the second rankine cycle system. At least one recuperator having a hot side and a cold side is disposed in the first rankine cycle system, second rankine cycle system, or combinations thereof. The at least one recuperator is configured to desuperheat and preheat the first working fluid, second working fluid, or combinations thereof.

In accordance with one exemplary embodiment disclosed herein, a waste heat recovery system including at least two integrated organic rankine cycle systems is provided. The system includes a combustion engine having an engine exhaust unit; and at least another heat source selected from a group comprising an oil heat exchanger, engine jacket, water jacket heat exchanger, lower temperature intercooler, higher temperature intercooler, or combinations thereof. A first organic rankine cycle system is coupled to the engine exhaust unit and configured to circulate a first organic working fluid. A second organic rankine cycle system is coupled to at least one other heat source selected from the group comprising the oil heat exchanger, engine jacket, water jacket heat exchanger, lower temperature intercooler, higher temperature intercooler, or combinations thereof, and configured to circulate a second organic working fluid. The one heat source includes a lower temperature heat source than at least one other heat source. The second organic rankine cycle system is configured to remove heat from the at least one other heat source. The first and second organic working fluids are circulatable in heat exchange relationship through a cascaded heat exchange unit for condensation of the first organic working fluid in the first organic rankine cycle system and evaporation of the second organic working fluid in the second organic rankine cycle system. At least one recuperator having a hot side and a cold side is disposed in the first rankine cycle system, second rankine cycle system, or combinations thereof. The at least one recuperator is configured to desuperheat and preheat the first working fluid, second working fluid, or combinations thereof.

### DRAWINGS

These and other features, aspects, and advantages of the present invention will become better understood when the following detailed description is read with reference to the accompanying drawings in which like characters represent like parts throughout the drawings, wherein:

FIG. 1 is a diagrammatical representation of a recuperated waste heat recovery system having two integrated organic rankine cycle systems in accordance with an exemplary embodiment disclosed herein;

FIG. 2 is a diagrammatical representation of a recuperated waste heat recovery system having two integrated organic rankine cycle systems in accordance with another exemplary embodiment disclosed herein; and

FIG. 3 is a diagrammatical representation of a recuperated waste heat recovery system having two integrated organic rankine cycle systems in accordance with yet another exemplary embodiment disclosed herein.

### DETAILED DESCRIPTION

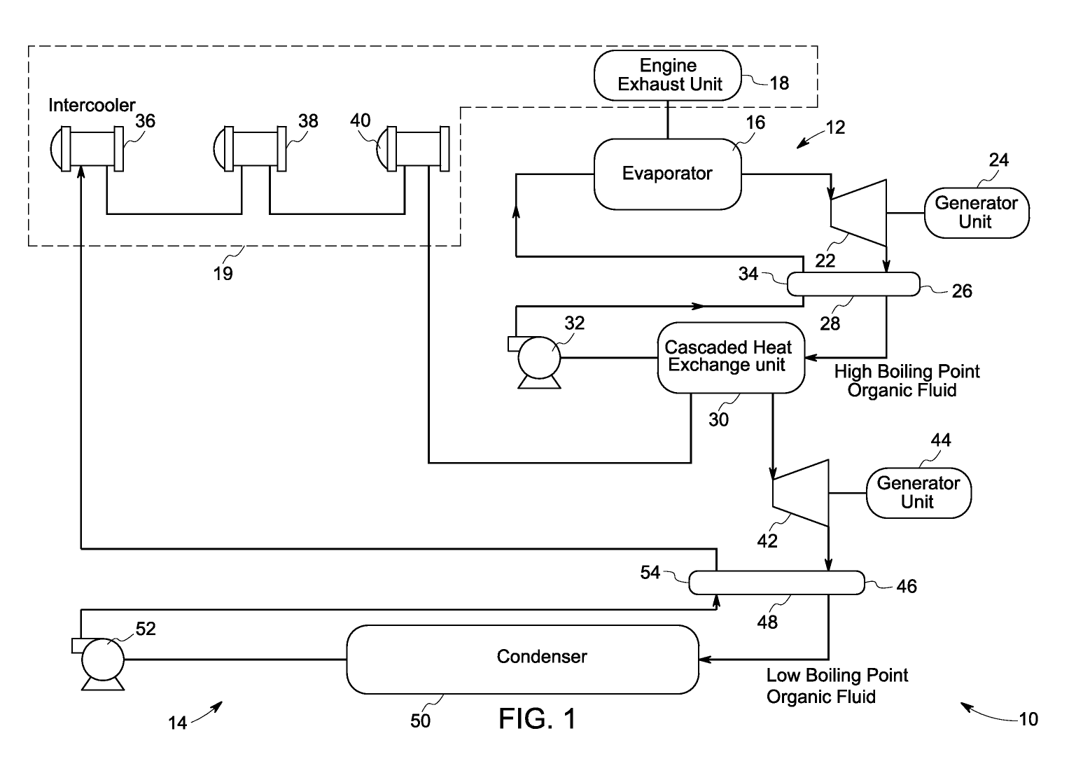

As discussed in detail below, embodiments of the present invention provide a waste heat recovery system having at least two integrated rankine cycle systems coupled to at least two separate heat sources respectively having different temperatures. The first rankine cycle system is coupled to a first heat source and configured to circulate a first working fluid. The second rankine cycle system is coupled to at least one second heat source and configured to circulate a second working fluid. The second heat source includes a lower temperature heat source than the first heat source. The waste heat recovery system also includes a cascaded heat exchange unit. The first and second working fluids are circulated in heat exchange relationship for condensation of the first working fluid in the first rankine cycle system and evaporation of the second working fluid in the second rankine cycle system. At least one recuperator having a hot side and a cold side is disposed in the first rankine cycle system, second rankine cycle system, or combinations thereof. The at least one recuperator is configured to desuperheat and preheat the first working fluid, second working fluid, or combinations thereof. The use of a recuperator facilitates a substantial increase of the cascaded organic rankine cycle system net power output for a lower investment, and consequently a decrease of the specific cost. In accordance with the exemplary embodiments of the present invention, the waste heat recovery system is integrated with multiple low-grade heat sources to allow a higher efficient recovery of waste heat for generation of electricity. Although the waste heat recovery system in the exemplary embodiments of FIGS. 1-3 is described with reference to combustion engines, the system is also applicable to other heat generation systems such as gas turbines, geothermal, solar, industrial and residential heat sources, or the like.

Referring to FIG. 1, a waste heat recovery system 10 is illustrated in accordance with an exemplary embodiment of the present invention. The illustrated waste heat recovery system 10 includes a first organic rankine cycle system 12 (top cycle) and a second organic rankine cycle system 14 (bottom cycle). A first organic working fluid is circulated through the first organic rankine cycle system 12. The first organic working fluid may include for example, cyclohexane, cyclopentane, thiophene, ketones, aromatics, or combinations thereof. The first organic rankine cycle system 12 includes an evaporator 16 coupled to a first heat source 18, for example an exhaust unit of a heat generation system 20 (for example, an engine). In one example, the temperature of the exhaust unit of the engine may be in the temperature range of 400 to 500 degrees Celsius. The evaporator 16 receives heat from the exhaust gas generated from the first heat source 18 and generates a first organic working fluid vapor. The first organic working fluid vapor is passed through a first expander 22 (which in one example comprises a radial type expander) to drive a first generator unit 24. In certain other exemplary embodiments, the first expander may be an axial type expander, impulse type expander, or high temperature screw type expander. In the illustrated embodiment, after passing through the first expander 22, the first organic working fluid vapor at a relatively lower pressure and lower temperature is passed through a hot side 26 of a recuperator 28 to a cascaded heat exchange unit 30. In other words, the first organic working fluid vapor is restored to its saturated state, or the superheat temperature is reduced before being fed to the cascaded heat exchange unit 30. The vapor quality of the desuperheated first organic working fluid is equal to one. The first organic working fluid vapor is condensed into a liquid. A first pump 32 is used to pump the condensed liquid from the cascaded heat exchange unit 30 to the evaporator 16 via a cold side 34 of the recuperator 28. In other words, the condensed first working fluid is preheated before being fed to the evaporator 16. The vapor quality of the preheated first organic working fluid is equal to zero. The cycle may then be repeated.

The cascaded heat exchange unit 30 is used both as a condenser for the first organic rankine cycle system 12 and as evaporator for the second organic rankine cycle system 14. A second organic working fluid is circulated through the second organic rankine cycle system 14. The second organic working fluid may include for example, propane, butane, pentafluoro-propane, pentafluoro-butane, pentafluoro-polyether, oil, or combinations thereof. It should be noted herein that the list of first and second organic working fluids are not inclusive and other organic working fluids applicable to organic rankine cycles are also envisaged. In certain other exemplary embodiments, the first or second organic working fluid includes a binary fluid. The binary fluid may include cyclohexane-propane, cyclohexane-butane, cyclopentane-butane, or cyclopentane-pentafluoropropane, for example. Cascaded heat exchange unit 30 may be coupled to any one or more of a plurality of second heat sources such as an intercooler 36, an oil heat exchanger 38, and a cooling water jacket heat exchanger 40. Such second heat sources are also typically coupled to the engine. In a more specific embodiment, cascaded heat exchange unit 30 is coupled to at least two second heat sources with the at least two second heat sources being coupled either in series or parallel. It should be noted herein that the second heat source includes a lower temperature heat source than the first heat source. In one example, the temperature of the second heat source may be in the range of 80 to 100 degrees Celsius. It should be noted that in other exemplary embodiments, first and second heat sources may include other multiple low-grade heat sources such as gas turbines with intercoolers. The cascaded heat exchange unit 30 receives heat from the first organic working fluid and generates a second organic working fluid vapor. The second organic working fluid vapor is passed through a second expander 42 (which in one example comprises a screw type compressor) to drive a second generator unit 44. In certain other exemplary embodiments, the second expander 42 may be a radial type expander, an axial type expander, or an impulse type expander. In certain other exemplary embodiments, the first expander 24 and the second expander 42 are coupled to a single generator unit.

In an exemplary embodiment, neither of the first and second organic working fluids are expanded below the atmospheric pressure, and the boiling point temperature of the first organic working fluid is below the average temperature of the second heat source. After passing through the second expander 42, the second organic working fluid vapor at lower pressure and lower temperature is passed through a hot side 46 of a recuperator 48 to a condenser 50. In other words, the second organic working fluid vapor is restored to its saturated state, or the superheat temperature is reduced before being fed to the cascaded heat exchange unit 30. The second organic working fluid vapor is then condensed into a liquid. A pump 52 is used to pump the condensed working fluid from the condenser 50 to the plurality of second heat sources via a cold side 54 of the recuperator 48. In other words, the condensed second working fluid is preheated before being fed to the plurality of second heat sources. In the illustrated embodiment, the second organic working fluid from the recuperator 48 is pumped sequentially via the intercooler 36, the oil heat exchanger 38, and the cooling water jacket heat exchanger 40. The cycle may then be repeated.

It should be noted herein that each of the recuperators 28, 48 has one-phase flow on both the hot and cold side. Specifically, in the first organic rankine cycle system 12, the first organic working fluid vapor from the outlet of the expander 22 is desuperheated via the hot side 26 of the desuperheater 28. The pressurized condensed first organic working fluid from the first pump 32 is preheated via the cold side 34 of the desuperheater 28. Similarly, in the second organic rankine cycle system 14, the second organic working fluid vapor from the outlet of the expander 42 is desuperheated via the hot side 46 of the desuperheater 48. The pressurized condensed second organic working fluid from the first pump 32 is preheated via the cold side 34 of the desuperheater 28.

As discussed previously, in conventional systems, the cooling of the superheated gas can be done either in a condenser/evaporator of the top loop or a condenser of the bottom loop. The heat of the desuperheating process is discarded to the bottom loop via the condenser/evaporator or to the ambient surroundings via the condenser of the bottom loop. In accordance with the exemplary embodiment of the present invention, the heat of the desuperheating process is used to preheat the condensed liquid before evaporation. The use of a recuperator enables a significant increase of the cascading organic rankine engine net power output. For example, with reference to the first organic rankine cycle system 12, the use of the recuperator 28 facilitates a higher temperature of the first organic working fluid at an inlet of the evaporator 16, a higher mass flow of the first organic working fluid, a higher power output/efficiency, a reduced heat input and reduced power output of the second organic rankine cycle system 14, but an increased overall net power output of the system 10. Although, in the illustrated embodiment, two recuperators 28, 48 are provided respectively for the first organic rankine cycle system 12 and the second rankine cycle system 14, in certain other embodiments, one recuperator may be provided either for the first organic rankine cycle system 12 or the second rankine cycle system 14. The use of a recuperators in one or both of the high and low temperature loop of a cascading organic rankine cycle allows to boost the cycle net power output at a reduced specific cost (Capex).

The cascaded organic rankine cycle system facilitates heat recovery over a temperature range that is too large for a single organic rankine cycle system to accommodate efficiently. In one embodiment, the intercooler 36, the oil heat exchanger 38, and the cooling water jacket heat exchanger 40 are coupled along a single cooling loop in which the second organic working fluid is heated and partially evaporated. The illustrated layout of the second heat sources facilitates effective heat removal from the plurality of lower temperature engine heat sources. This increases the effectiveness of the cooling systems and provides effective conversion of waste heat into electricity.

In another exemplary embodiment of the present invention, the heat generation system may include a gas turbine system. Steam may be circulated through the top cycle and the second organic working fluid may be circulated through the bottom cycle. Steam is condensed and passed in heat exchange relationship with the second organic working fluid through the cascaded heat exchange unit 30.

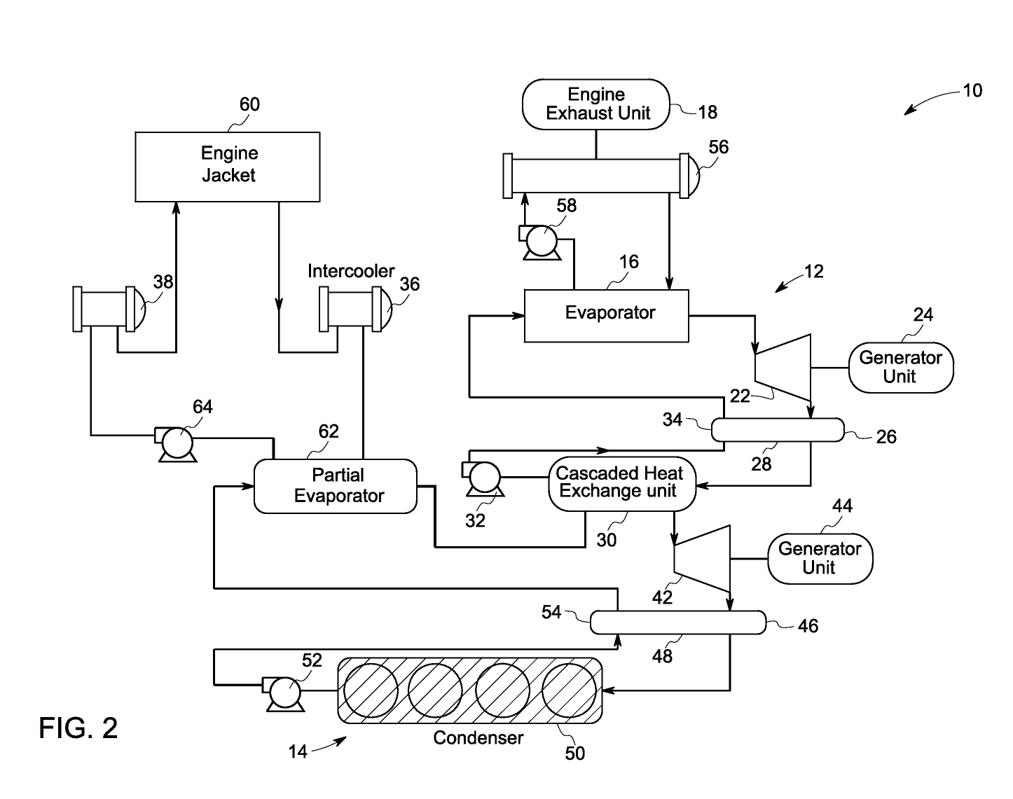

Referring to FIG. 2, a waste heat recovery system 10 is illustrated in accordance with another exemplary embodiment of the present invention. As discussed above, the illustrated waste heat recovery system 10 includes the first organic rankine cycle system 12 and the second organic rankine cycle system 14. In the illustrated embodiment, the first organic rankine cycle system 12 includes the evaporator 16 coupled to the first heat source 18, i.e. the exhaust unit of the engine, via a thermal oil heat exchanger 56. In the illustrated embodiment, the thermal oil heat exchanger 56 is a shell and tube type heat exchanger. The thermal oil heat exchanger 56 is used to heat thermal oil to a relatively higher temperature using exhaust gas of the engine. In one example, the thermal oil is heated from 160 to 280 degrees Celsius. The evaporator 16 receives heat from the thermal oil and generates a first organic working fluid vapor. The thermal oil is then pumped back from the evaporator 16 to the thermal oil heat exchanger 56 using a pump 58.

As discussed in the previous embodiment, after passing through the first expander 22, the first organic working fluid vapor at a relatively lower pressure and lower temperature is passed through the hot side 26 of the recuperator 28 to the cascaded heat exchange unit 30. The first pump 32 is used to pump the condensed liquid from the cascaded heat exchange unit 30 to the evaporator 16 via the cold side 34 of the recuperator 28.

With reference to the second organic rankine cycle system 14, after passing through the second expander 42, the second organic working fluid vapor at lower pressure and lower temperature is passed through the hot side 46 of the recuperator 48 to the condenser 50. The pump 52 is used to pump the condensed working fluid from the condenser 50 to the plurality of second heat sources via the cold side 54 of the recuperator 48.

In the illustrated embodiment, the cascaded heat exchange unit 30 is coupled to a plurality of second heat sources such as the intercooler 36, the oil heat exchanger 38, and an engine jacket 60 via a partial evaporator 62. The partial evaporator 62 receives heat from a cooling water loop that collects heat from the oil heat exchanger 38, the engine jacket 60, and the intercooler 36 and generates a partially evaporated second organic working fluid two-phase stream. The second organic working fluid stream is passed through the cascaded heat exchange unit 30 for complete evaporation or even superheating of the second organic working fluid. The partial evaporator 62 is configured to partially evaporate the liquid being supplied to the cascaded heat exchange unit 30. The fluid in the cooling water loop is pumped via a pump 64 to the oil heat exchanger 38, before being supplied to the engine jacket, 60, and the intercooler 36 before it enters the partial evaporator 62. The cycle may then be repeated.

In one example, with reference to a conventional cascading system, the first organic working fluid vapor of the top loop may be at a temperature of 158 degrees Celsius, pressure of 1.9 bars, and vapor quality of one at the exit of the expander. The condensed first organic working fluid may be at a temperature of 92 degrees Celsius, pressure of 18.3 bars, and vapor quality of zero at the inlet of the evaporator. The power output of the top loop may be 65.2 Kilowatt Electric and power output of the bottom loop may be 79.5 Kilowatt Electric. In accordance with the embodiment of the present invention, the expanded first organic working fluid vapor at the inlet of the recuperator 28 may be at a temperature of 169 degrees Celsius, pressure of 2 bars, and vapor quality equal to one. The desuperheated first organic working fluid at the exit of the recuperator 28 may be at a temperature of about 104 degrees Celsius, a pressure of about 1.8 bars, and a vapor quality equal to about one. The condensed first organic working fluid at the inlet of the recuperator 28 may be at a temperature of 92 degrees Celsius, pressure of 18.4 bars, and vapor quality equal to zero. The preheated first working fluid at the exit of the recuperator 28 may be at a temperature of 146 degrees Celsius, pressure of 18.4 bars, and vapor quality equal to zero. The power output of the top loop may be 81.9 Kilowatt Electric and power output of the bottom loop may be 78.5 Kilowatt Electric. It should be noted herein that the values of temperature, and pressure discussed above are exemplary values and should no way be construed as limiting. The values may vary depending on the application.

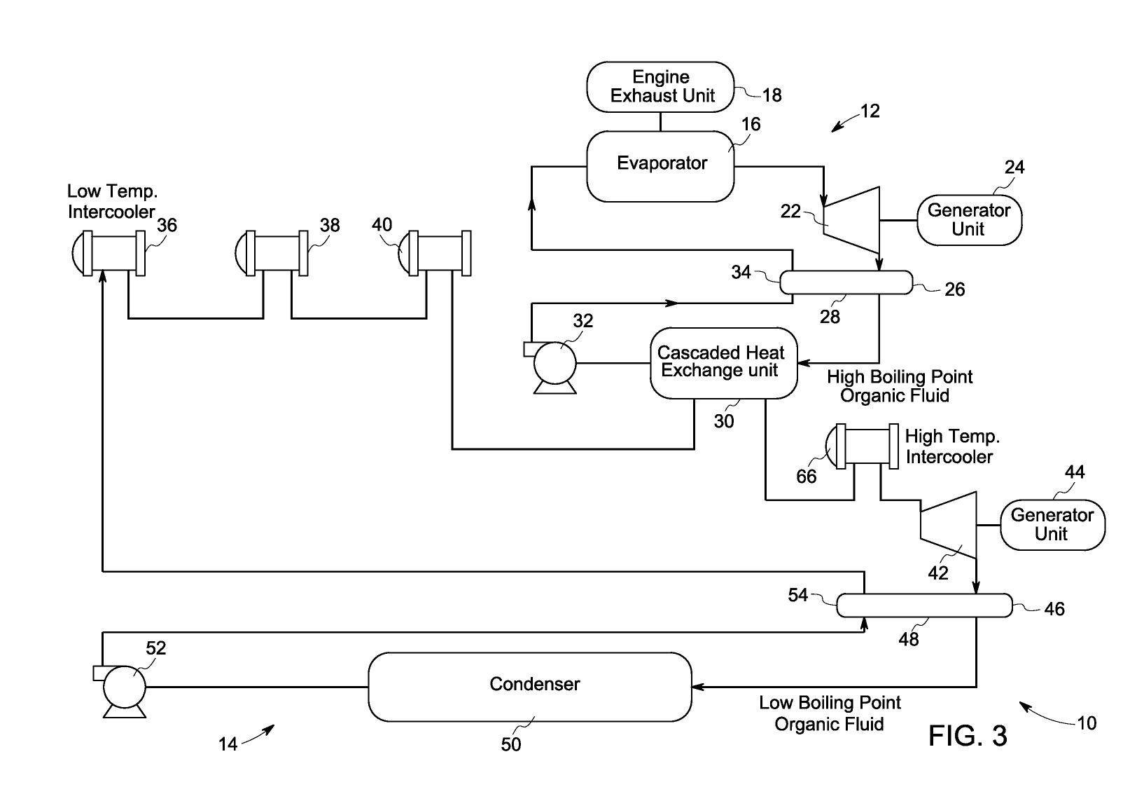

Referring to FIG. 3, a waste heat recovery system 10 is illustrated in accordance with another exemplary embodiment of the present invention. Similar to the previous two embodiments, after passing through the first expander 22, the first organic working fluid vapor at a relatively lower pressure and lower temperature is passed through the hot side 26 of the recuperator 28 to the cascaded heat exchange unit 30. The first pump 32 is used to pump the condensed liquid from the cascaded heat exchange unit 30 to the evaporator 16 via the cold side 34 of the recuperator 28.

In the illustrated embodiment, the cascaded heat exchange unit 30 is coupled to a plurality of second heat sources such as the intercooler 36, the oil heat exchanger 38, and the water jacket heat exchanger 40. The second heat sources are used to preheat or partially vaporize the second organic working fluid entering the cascading heat exchange unit 30. In the illustrated embodiment, the intercooler 36 is a lower temperature intercooler. The cascaded heat exchange unit 30 receives heat from the first organic working fluid and generates a second organic working fluid vapor. The second organic working fluid vapor is passed through a higher temperature intercooler 66 to the second expander 42 to drive the second generator unit 44. In the illustrated embodiment, the lower temperature intercooler 36 performs preheating of the second organic working fluid flowing to the cascaded heat exchange unit 30. The higher temperature intercooler 66 provided downstream of the cascaded heat exchange unit 30 is used to heat the second organic working fluid exiting from the cascaded heat exchange unit 30 to a relatively higher temperature, to complete evaporation or to superheat the second organic working fluid. The provision of the lower temperature intercooler 36 and the higher temperature intercooler 66 respectively to both upstream and downstream of the cascaded heat exchange unit 30 facilitates effective heating of the second organic working fluid and thereby enable effective heat recovery.

Again as discussed above, after passing through the second expander 42, the second organic working fluid vapor at lower pressure and lower temperature is passed through the hot side 46 of the recuperator 48 to the condenser 50. The pump 52 is used to pump the condensed working fluid from the condenser 50 to the plurality of second heat sources via the cold side 54 of the recuperator 48. In the illustrated embodiment, the second organic working fluid is sequentially passed through the lower temperature intercooler 36, the oil heat exchanger 38, and the water jacket heat exchanger 40 before entering the cascading heat exchange unit 30.

It should be noted herein that in other embodiments of the exemplary recuperated waste heat recovery system, the number of second heat sources such as intercoolers, oil heat exchangers, jacket heat exchangers, evaporators and their relative positions in the second organic rankine cycle system may be varied depending the application. All such permutations and combinations are envisaged. Various such permutations and combinations discussed in U.S. patent application Ser. No. 11/770,895 filed on Jun. 29, 2007 is incorporated herein by reference.

While only certain features of the invention have been illustrated and described herein, many modifications and changes will occur to those skilled in the art. It is, therefore, to be understood that the appended claims are intended to cover all such modifications and changes as fall within the true spirit of the invention.

1. A waste heat recovery system including at least two integrated rankine cycle systems, the recovery system comprising:
a heat generation system comprising at least two separate heat sources having different temperatures;
a first rankine cycle system coupled to a first heat source among the at least two separate heat sources and configured to circulate a first working fluid; wherein the first rankine system is configured to remove heat from the first heat source;
a second rankine cycle system coupled to at least one second heat source among the at least two separate heat sources and configured to circulate a second working fluid, the at least one second heat source comprising a lower temperature heat source than the first heat source, wherein the second rankine cycle system is configured to remove heat from the at least one second heat source;
a cascaded heat exchange unit, wherein the first and second working fluids are circulatable in heat exchange relationship through the cascaded heat exchange unit for condensation of the first working fluid in the first rankine cycle system and evaporation of the second working fluid in the second rankine cycle system;
at least one recuperator comprising a hot side and a cold side disposed in the first rankine cycle system, second rankine cycle system, or combinations thereof; wherein the at least one recuperator is configured to desuperheat and preheat the first working fluid, second working fluid, or combinations thereof.

2. The recovery system of claim 1, wherein the first rankine cycle system comprises an evaporator coupled to the first heat source, and wherein the first heat source comprises an engine exhaust unit.

3. The recovery system of claim 2, wherein the first rankine cycle system further comprises a first expander; wherein the first expander comprises at least one radial type expander, or axial type expander, or high temperature screw type or impulse type expander.

4. The recovery system of claim 3, wherein the first expander is coupled to the cascaded heat exchange unit via the hot side of the recuperator.

5. The recovery system of claim 3, wherein the vaporized first working fluid is fed from the first expander to the cascaded heat exchange unit via the hot side of the recuperator.

6. The recovery system of claim 5, wherein the first rankine cycle system further comprises a first pump, wherein the first pump is coupled to the evaporator via the cold side of the recuperator.

7. The recovery system of claim 6, wherein the first pump is configured to feed the condensed first working fluid from the cascaded heat exchange unit to the evaporator via the cold side of the recuperator.

8. The recovery system of claim 7, wherein the vaporized first working fluid is desuperheated before fed to the cascaded heat exchange unit.

9. The recovery system of claim 7, wherein the condensed first working fluid from the cascaded heat exchange unit is preheated before fed to the first evaporator.

10. The recovery system of claim 1, wherein the first working fluid comprises steam or organic working fluid.

11. The recovery system of claim 1, wherein the second rankine cycle system comprises a second expander, wherein the second expander comprises a screw type compressor, or a radial type expander, or an axial type expander, or an impulse type expander.

12. The recovery system of claim 11, wherein the second rankine cycle system further comprises a condenser, wherein the second expander is coupled to the condenser via the hot side of the recuperator.

13. The recovery system of claim 12, wherein the vaporized second working fluid is fed from the second expander to the condenser via the hot side of the recuperator.

14. The recovery system of claim 13, wherein the second rankine cycle system further comprises a second pump, wherein the second condenser is coupled to the at least one second heat source selected from a group comprising an oil heat exchanger, an engine jacket, a water jacket heat exchanger, a lower temperature intercooler, a higher temperature intercooler, or combinations thereof via the second pump.

15. The recovery system of claim 14, wherein the second pump is configured to feed the condensed second working fluid from the condenser to the at least one second heat source via the cold side of the recuperator.

16. The recovery system of claim 15, further comprising a partial evaporator; wherein the second pump is coupled via the cold side of the recuperator to the at least one second heat source selected from the group comprising the oil heat exchanger, the engine jacket, the water jacket heat exchanger, the engine jacket, the lower temperature intercooler, the higher temperature intercooler, or combinations thereof through the partial evaporator configured to partially evaporate the second working fluid before entering the cascaded heat exchange unit.

17. The recovery system of claim 15, wherein the vaporized second working fluid is desuperheated before fed to the condenser.

18. The recovery system of claim 17, wherein the condensed second working fluid from the condenser is preheated before fed to the partial evaporator.

19. The recovery system of claim 17, wherein the condensed second working fluid from the condenser is preheated before fed to the at least one second heat source.

20. The recovery system of claim 1, wherein the second working fluid comprises an organic working fluid.

21. A waste heat recovery system including at least two integrated organic rankine cycle systems, the recovery system comprising:
a combustion engine comprising one heat source having an engine exhaust unit; and at least one other heat source selected from a group comprising an oil heat exchanger, an engine jacket, a water jacket heat exchanger, a lower temperature intercooler, a higher temperature intercooler, or combinations thereof;
a first organic rankine cycle system coupled to the engine exhaust unit and configured to circulate a first organic working fluid; wherein the first organic rankine system is configured to remove heat from the engine exhaust unit;
a second organic rankine cycle system coupled to the at least one other heat source selected from the group comprising the oil heat exchanger, the engine jacket, the water jacket heat exchanger, the lower temperature intercooler, the higher temperature intercooler, or combinations thereof; and configured to circulate a second organic working fluid, the one heat source comprising a higher temperature heat source than the at least one other heat source, wherein the second organic rankine cycle system is configured to remove heat from the at least one other heat source; and
a cascaded heat exchange unit, wherein the first and second organic working fluids are circulatable in heat exchange relationship through the cascaded heat exchange unit for condensation of the first organic working fluid in the first organic rankine cycle system and evaporation of the second organic working fluid in the second organic rankine cycle system; and
at least one recuperator comprising a hot side and a cold side disposed in the first rankine cycle system, second rankine cycle system, or combinations thereof; wherein the at least one recuperator is configured to desuperheat and preheat the first working fluid, second working fluid, or combinations thereof.

22. The recovery system of claim 21, wherein the first organic rankine cycle system comprises a first expander coupled to the cascaded heat exchange unit via the hot side of the recuperator.

23. The recovery system of claim 22, wherein the vaporized first organic working fluid is fed from the first expander to the cascaded heat exchange unit via the hot side of the recuperator.

24. The recovery system of claim 23, wherein the first organic rankine cycle system further comprises a first pump, wherein the first pump is coupled to a first evaporator via the cold side of the recuperator.

25. The recovery system of claim 24, wherein the first pump is configured to feed the condensed first organic working fluid from the cascaded heat exchange unit to the evaporator via the cold side of the recuperator.

26. The recovery system of claim 25, wherein the vaporized first organic working fluid is desuperheated before fed to the cascaded heat exchange unit.

27. The recovery system of claim 25, wherein the condensed first working fluid from the cascaded heat exchange unit is preheated before fed to the first evaporator.

28. The recovery system of claim 21, wherein the second organic rankine cycle system comprises a second expander, wherein the second expander comprises a screw type compressor, or a radial type expander, or an axial type expander, or an impulse type expander.

29. The recovery system of claim 28, wherein the second organic rankine cycle system further comprises a condenser, wherein the second expander is coupled to the condenser via the hot side of the recuperator.

30. The recovery system of claim 29, wherein the vaporized second organic working fluid is fed from the second expander to the condenser via the hot side of the recuperator.

31. The recovery system of claim 29, wherein the second organic rankine cycle system further comprises a second pump, wherein the second condenser is coupled to the at least one second heat source selected from a group comprising an oil heat exchanger, an engine jacket, a water jacket heat exchanger, a lower temperature intercooler, a higher temperature intercooler, or combinations thereof via the second pump.

32. The recovery system of claim 31, wherein the second pump is configured to feed the condensed second organic working fluid from the condenser to the at least one second heat source via the cold side of the recuperator.

33. The recovery system of claim 32, further comprising a partial evaporator; wherein the second pump is coupled via the cold side of the recuperator to the at least one second heat source selected from the group comprising the oil heat exchanger, the engine jacket, the water jacket heat exchanger, the engine jacket, the lower temperature intercooler, the higher temperature intercooler, or combinations thereof through the partial evaporator configured to partially evaporate the second organic working fluid before entering the cascaded heat exchange unit.

34. The recovery system of claim 33, wherein the vaporized second organic working fluid is desuperheated before fed to the condenser.

35. The recovery system of claim 34, wherein the condensed second organic working fluid from the condenser is preheated before fed to the partial evaporator.

36. The recovery system of claim 31, wherein the condensed second organic working fluid from the condenser is preheated before fed to the at least one second heat source.
